(19) United States
(12) Patent Application Publication
(10) Pub. No.: US 2014/0006436 A1
(43) Pub. Date: Jan. 2, 2014

(54) Systems and Methods for Connecting Travelers with Natives for an At-Home Culinary Experience

(71) Applicant: Richard Paul Bonfiglio, Murrysville, PA (US)

(72) Inventor: Richard Paul Bonfiglio, Murrysville, PA (US)

(21) Appl. No.: 13/925,378

(22) Filed: Jun. 24, 2013

Related U.S. Application Data
(63) Continuation-in-part of application No. 13/537,393, filed on Jun. 29, 2012.

(51) Int. Cl. G06F 17/30

(52) U.S. Cl. CPC G06F 17/30861
USPC 707/758

(57) ABSTRACT

The present invention provides systems and methods for connecting a traveler traveling to a geographic location on business and/or pleasure with one or more natives of the geographic location in order to enrich the traveler's experience of the geographic region and enhance the traveler's knowledge of the culture, customs and social etiquette of the geographic location by having the traveler share a home-cooked meal prepared, served, hosted and eaten with the native in the native's residence, referred to as an “at home culinary experience.”

### CROSS REFERENCE TO RELATED APPLICATIONS

This application is a continuation-in-part of U.S. application Ser. No. 13/537,393, filed Jun. 29, 2012, which is incorporated by reference herein.

### FIELD OF THE INVENTION

The invention relates to an online matching service and, in particular, to an computer-implemented system and method for connecting a person traveling to geographic region with one or more natives of that geographic region in order to share a home-cooked meal in the home of the native and prepared and hosted by the native.

### BACKGROUND OF THE INVENTION

Of the seven billion people worldwide, close to one billion people travel internationally each year for business and/or pleasure. Tourists visiting foreign countries usually follow prescribed itineraries. Travel guides typically present highlights of destinations including historical and cultural sites, predetermined eateries and travel stops and staid travel stories. Even for tourists that devise their own travel itinerary and agenda, without having local contacts, interactions with natives of a particular country generally are limited, especially if a language barrier exists. International travelers rarely experience home-made native cuisine or learn about native customs, opinions, beliefs, family histories or aspirations from natives themselves.

A need exists, therefore, to provide a way for international travelers and natives to meet and interact in order to enrich the experience of the international traveler as well as bring people from disparate parts of the world together in a more personalized and meaningful setting.

### SUMMARY OF THE INVENTION

The present invention fulfills this need by providing systems and methods for connecting a person, i.e., traveler, traveling to a geographic location for business or pleasure with one or more natives of the geographic location in order to enrich the traveler's experience of the geographic region and enhance the traveler's knowledge of the culture, customs and social etiquette of the geographic location by sharing a home-cooked meal with the native in the native's residence, referred to herein as an “at-home culinary experience.”

In an aspect of the invention, there is provided a computer-implemented system provided by an online matching service for matching a person traveling to a geographic region and wishing to experience an at-home culinary experience in the home of a native of the geographic region. The computer-implemented system is comprised of a web server processor or a local server processor, a web server database or a local server database, and a matching algorithm, referred to as a traveler-native match algorithm. The web server processor or the local server processor executes the traveler-native match algorithm using information provided by the person traveling to the geographic region, referred to as a traveler-seeker, and by the one or more natives residing in the geographic region, referred to as a native-offeror, stored in memory in the web server database or the local server database so that matches may be identified between the traveler-seeker and the one or more native-offerors. The traveler-seeker, wishing to experience a home-cooked meal in a residence of one or more natives of the geographic region, and the one or more native-offerors, wishing to offer a home-cooked meal and to eat the home-cooked meal in their home with a person traveling to their geographic region, each access the online matching service in order to enter certain information. The online matching service includes a registration process, an acceptance process, and a matching process.

In another aspect of the invention, there is provided a computer-implemented method for providing a person traveling to a region an at-home culinary experience in the home of a native of the region. The computer-implemented method is comprised of: (1) accessing a computer-implemented system by a person traveling to a geographic region, referred to as a traveler-seeker, the traveler-seeker wishing to experience a home-cooked meal in a residence of one or more natives of the geographic region; and by one or more natives residing in the geographic region, referred to as a native-offeror, the native-offeror wishing to offer a home-cooked meal and eating the home-cooked meal in their home with a person traveling to their geographic region, in which access is accomplished via the internet or via a telephone, and the computer-implemented system is provided by an online matching service; (2) registering for the online matching service by the traveler-seeker and the one or more native-offerors, registration comprised of the traveler-seeker and the one or more native-offerors filling out a questionnaire by providing information, referred to as “attributes,” in which the information is entered into a web server database or a local server database; (3) accepting the traveler-seeker and the one or more native-offerors by the online matching service, acceptance comprised of the online matching service verifying the truthfulness of the information provided by the traveler-seeker and the one or more native-offerors in their respective questionnaires, and conducting a background investigation of the traveler-seeker and the one or more of native-offerors to confirm that the traveler-seeker and/or the one or more native-offerors have no criminal history; (4) matching the traveler-seeker with the one or more native-offerors, the matching performed by a web server processor or a local server processor which executes a matching algorithm, referred to as a traveler-native match algorithm, using the information stored in memory in the web server database or in the local server database, in order to identify any matches between the traveler-seeker and the one or more native-offerors; and (5) reporting the results of the database search by the web server processor or the local server processor to the traveler-seeker.

### BRIEF DESCRIPTION OF THE DRAWINGS

A fuller understanding of the invention can be gained from the following description when read in conjunction with the accompanying drawings in which:

FIG. 1 illustrates the functionality of the online matching service systems and methods in accordance with the invention;

FIG. 2 illustrates the traveler-native matching algorithm in accordance with the invention; and

FIG. 3 illustrates an overview of the system in accordance with the invention.

### DETAILED DESCRIPTION OF THE INVENTION

As used herein, the term “at-home culinary experience” is meant to refer to a native-offeror preparing home-made food in his/her residence and sharing and eating the home-made food with a traveler-seeker in the native-offeror' s residence.

As used herein, the term “geographic location” is meant to refer to a particular locale traveled to by a traveler-seeker, such as, without limitation, a village, a town, a state, a region or a country.

As used herein, the term “native(s)” is interchangeable with the terms “native people(s)”, native person(s) and “indigenous people(s)”, all of which are meant to refer to a person born in a particular geographic location and residing in that geographic location.

As used herein, the term “native-offeror” is meant to refer to a person who wishes to share knowledge of their country with a traveler-seeker by offering to cook, share, eat and host the traveler-seeker in their home.

As used herein, the term “registrant” is meant to refer to either a traveler-seeker or a native-offeror.

As used herein, the term “server” is meant to refer to a system comprised of software and suitable computer hardware including a central processing unit (CPU), (i.e., a processor), memory, and memory combined with the processor.

As used herein, the term “traveler,” “international traveler” and “tourist” are interchangeable, all of which are meant to refer to a person (and any traveling companions) who travels away from home for purposes of pleasure and sightseeing, as well as a person (and any traveling companions) traveling to a geographic location for business but also interested in exploring, sightseeing and/or learning about the geographic location and their native people.

As used herein, the term “traveler-seeker” is meant to refer to a person traveling to a geographic location and seeking to interact more meaningfully with natives from the geographic location by having the experience of a home-cooked meal prepared and served by the native, and shared and eaten with the native, in the native's residence.

The systems and methods of the present invention for providing an at-home culinary experience is designed to provide a person traveling to a geographic region, i.e., traveler, with a more meaningful experience of the geographic region by having them interact with one or more native persons of the geographic location in the residence of the one or more native persons, whereby the one or more native persons prepares and serves their favorite, home-cooked food in their residence, and then shares and eats the home-cooked food with the traveler.

In an embodiment of the invention, there is provided a computer-implemented system provided by an online matching service for matching a person traveling to a geographic region and wishing to experience an at-home culinary experience in the home of a native of the geographic region comprised of a web server processor or a local server processor, a web server database or a local server database, and a matching algorithm, referred to as a traveler-native match algorithm. The web server processor or the local server processor executes the traveler-native match algorithm using information provided by the person traveling to the geographic region, referred to as a traveler-seeker, and by the one or more natives residing in the geographic region, referred to as a native-offeror, stored in memory in the web server database or the local server database so that matches may be identified between the traveler-seeker and the one or more native-offerors. The traveler-seeker, wishing to experience a home-cooked meal in a residence of one or more natives of the geographic region, and the one or more native-offerors, wishing to offer a home-cooked meal and to eat the home-cooked meal in their home with a person traveling to their geographic region, each access the online matching service in order to enter certain information.

Access to the online matching service by the traveler-seeker and the one or more native-offerors is via the internet using a computer, smartphone, tablet or any other form of access to the internet which accesses a web server, or via a land-line telephone, mobile telephone or any other type of telephone which accesses a local server connected to the web server via a proprietary network, such as AT&T or MCI.

Traveler-seekers and native-offerors, collectively referred to as “registrants,” after accessing the online matching service begin a three-step process which includes a registration process, an acceptance process, and a matching process.

The registration process includes the traveler-seeker and the one or more native-offerors filling out a questionnaire by providing information, referred to as “attributes,” which information is entered into the web server database or the local server database. The acceptance process includes verifying the truthfulness of the information provided by the traveler-seeker and the one or more native-offerors in their respective questionnaires by the online matching service, and conducting a background investigation of the traveler-seeker and the one or more of native-offerors to determine if the traveler-seeker and/or the one or more native-offerors have a criminal history. The matching process includes execution of the traveler-match algorithm by the web server processor or the local server processor using the information received from the traveler-seeker and the one or more native-offerors stored in memory in the web server database or the local server database.

After execution of the matching algorithm, results of the search are reported by the online matching service to the traveler-seeker. When no matches are found, one of three actions occurs: (1) the search ends; (2) the traveler-seeker revises certain attributes in the questionnaire, the server processor repeats the search using the revised information, and results of the search are reported to the traveler-seeker, whereby the traveler-seeker can decide to take action (1), thus ending the second search, or take action (2) as many times as they wish until the traveler-seeker decides to end the search or one or more matches are identified; or (3) the server repeats the search a set number of times at a predetermined interval, and results of the search are reported to the traveler-seeker after identification of a match or when no match is identified. Which one of actions (1) or (3) the traveler-seeker prefers is provided in the traveler-seeker's questionnaire.

Attributes entered into the web server database or into the local server database include mandatory attributes and optional attributes. Exemplary mandatory and optional attributes of the traveler-seeker and of the native-offeror, as provided in their questionnaires, are shown below in Tables 1 and 2, respectively.

Suitable meal formats in accordance with the invention include a sit-down or a buffet breakfast, brunch, lunch, dinner or picnic.

In accordance with the invention, it is contemplated that the online matching service charges a first fee to the traveler-seeker for searching the server database one or more times, and a second fee after the traveler-seeker chooses to partake in the at-home culinary experience with one or more matched native-offerors identified by the traveler-native match algorithm. It also is contemplated that the one or more native-offerors receive monetary compensation from the online matching service after successful completion of the at-home culinary experience with the traveler-seeker, which successful completion is reported to the online matching service by both the traveler-seeker and the one or more native offerors.

In another embodiment of the invention, there is provided a computer-implemented method for providing a person traveling to a region an at-home culinary experience in the home of a native of the region. The computer-implemented method is comprised of: (1) accessing a computer-implemented system described above by a traveler-seeker, the traveler-seeker wishing to experience a home-cooked meal in a residence of one or more natives of the geographic region; and by one or more native-offerors, the one or more native-offerors wishing to offer a home-cooked meal and eating the home-cooked meal in their home with a person traveling to their geographic region, in which access is accomplished via the internet or via a telephone, and the computer-implemented system is provided by an online matching service; (2) registering for the online matching service by the traveler-seeker and the one or more native-offerors, registration comprised of the traveler-seeker and the one or more native-offerors filling out a questionnaire by providing information, referred to as “attributes,” in which the information is entered into a web server database or a local server database; (3) accepting the traveler-seeker and the one or more native-offerors by the online matching service, acceptance comprised of the online matching service verifying the truthfulness of the information provided by the traveler-seeker and the one or more native-offerors in their respective questionnaires, and conducting a background investigation of the traveler-seeker and the one or more of native-offerors to confirm that the traveler-seeker and/or the one or more native-offerors have no criminal history; (4) matching the traveler-seeker with the one or more native-offerors, the matching performed by a web server processor or a local server processor which executes a matching algorithm, referred to as a traveler-native match algorithm, using the information stored in memory in the web server database or in the local server database, in order to identify any matches between the traveler-seeker and the one or more native-offerors; and (5) reporting the results of the database search by the web server processor or the local server processor to the traveler-seeker and to any matched native-offerors.

TABLE 1
Traveler-Seeker Questionnaire

*1. Name
*2. Street Address, City, County, State, Country, Zip Code
*3. Contact information: Business and home telephone, mobile phone,
email address; and communication preference with online matching
service.
*4. Date of Birth
*5. Gender
*6. Language(s) spoken
*7. Marital Status single/married
*8. Current occupation
*9. List the geographic location(s) you will be visiting. Is this trip business
or pleasure?
*10. What dates and times will you be in the geographic location(s)?
*11. Check the format of the culinary experience you prefer: (1) Buffet,
Sit-down, No Preference; and (2) Breakfast, Brunch, Lunch, Dinner,
Picnic, No Preference
*12. Indicate any dietary restrictions you have, including alcohol
*13. If other people are accompanying you to the at-home culinary
experience, list their name(s), age(s), and their relationship to you
14. List any hobbies and personal interests you have
15. Optionally, provide religious affiliation and/or spiritual beliefs
16. List any other information you believe is important regarding your
preferences and/or restrictions
*17. Have you ever been convicted of a crime? If so, please provide
details
*18. When no match is found, provide (a) the number of times you want
the search repeated; and (b) if you want additional searches, circle the
time interval between additional search(es): once/day; every two days;
twice/week; once/week; twice/month; other. If “other”, specify time
interval desired.

TABLE 2
Native-Offeror Questionnaire

*1. Name
*2. Street Address, City, County, State, Country, Zip Code
*3. Contact information: Business and home telephone, mobile phone,
email address; and communication preference with online matching
service.
4. Rent or Own Residence
*5. Date of Birth
*6. Gender
*7. Language(s) spoken
*8. Marital Status single/married
*9. Current occupation
*10. Number of people living in residence, and number of children
*11. Provide date(s) and time(s) you are available to host an at-home
culinary experience
*12. Provide information regarding meal formats and food items you can
offer
*13. Dietary/alcohol restrictions
*14. List the maximum number of people you can accommodate for the
at-home culinary experience
15. List any hobbies and personal interests you have
16. Optionally, provide religious affiliation and/or spiritual beliefs
17. List any other information you believe is important regarding your
hosting of an at-home culinary experience
*18. Have you ever been convicted of a crime? If so, provide details

Answers to questions preceded by an asterisk are considered mandatory answers, referred to as “mandatory attributes,” in that they must be answered and are entered into the server database. Both traveler-seekers and native-offerors have the option to supply answers to the other questions, referred to as “optional attributes,” which also will be entered into the server database. The invention contemplates that any answer provided by a traveler-seeker or a native-offeror which is deemed to be of a negative nature, i.e., unsuitable, unrealistic, immoral, unethical, biased-based or illegal, will be rejected from inclusion in the server database and the acceptance of that traveler-seeker or native-offeror will be revoked.

In accordance with the invention, any standard background investigation may be performed such as, without limitation, compilation and review of employment, financial and criminal records of the registrants.

Acceptance is conditioned on registrants of the online matching service answering all questions honestly, with no answers of a negative nature as described above, and not having a criminal history. If accepted, a registrant is notified via their preferred means of communication (as indicated in their questionnaire) and given a password to access the online matching service. After gaining access to the online matching service, the registrants sign a service contract. The service contract contains standard clauses typically found in service contracts, such as, without limitation, details of the services that the online matching service provides, charges and payment particulars, liability clauses, and other standard clauses typically contained in service contracts.

In the case of a traveler-seeker, the service contract also includes the maximum number of database search iterations the traveler-seeker wishes to have executed if the first iteration does not result in finding one or more native-offerors to host the at-home culinary experience. The service contract also includes information regarding the cost of the online matching service.

Specifically, the invention contemplates that the traveler-seeker will make up to two payments. The first payment is charged after the traveler-seeker signs the service contract. The second payment is charged to the traveler-seeker when all of the following events occur: one or more native-offerors are found that match the mandatory and any optional attributes of the traveler-seeker after running one or more database searches (either the number of searches indicated by the traveler-seeker or the number of revised searches); the traveler-seeker consents to participating in an at-home culinary experience hosted by at least one of the one or more of the native-offerors in the residence of the native-offeror; the one or more native-offerors are contacted and provided information regarding the traveler-seeker to whom they have been matched; and a confirmation by the one or more native-offerors to host the traveler-seeker is received by the online matching service. It is expected that the second payment will increase incrementally depending on the number of native-offerors the traveler-seeker chooses to partake in the at-home culinary experience. In addition, a second payment may be charged to the traveler-seeker in the case when no matches are found after running the database search one or more times, each time with revised attributes entered in the database.

The invention contemplates that after the traveler-seeker receives notification that one or more native-offerors have been identified, the traveler-seeker is given the information provided by the one or more native-offerors in their questionnaire so that the traveler-seeker can decide whether to contact the one or more native-offerors in order to arrange the at-home culinary experience in the residence of the one or more native-offerors when the traveler-seeker travels to their geographic region.

In the case of a native-offeror, the service contract also includes the amount of monetary compensation the native-offeror can expect to receive from the online matching service after successfully preparing, serving, eating and hosting an at-home culinary experience for a traveler-seeker. The invention contemplates that the native-offeror will receive monetary compensation from the online matching service after successful completion of the at-home culinary experience with the traveler-seeker, which verification is provided to the online matching service by both the traveler-seeker and the native-offeror.

Any suitable service contract commonly used by those in the service business arts is contemplated for use in the systems and methods of the present invention.

The matching process includes entering a traveler-seeker's mandatory and any optional attributes into a web server database or a local server database after the traveler-seeker signs the service contract and submits the first payment, and entering a native-offeror' s mandatory and any optional attributes into a web server database or a local server database after the native-offeror signs the service contract. The matching of traveler-seekers to native-offerors is accomplished by the traveler-native matching algorithm, described in detail below.

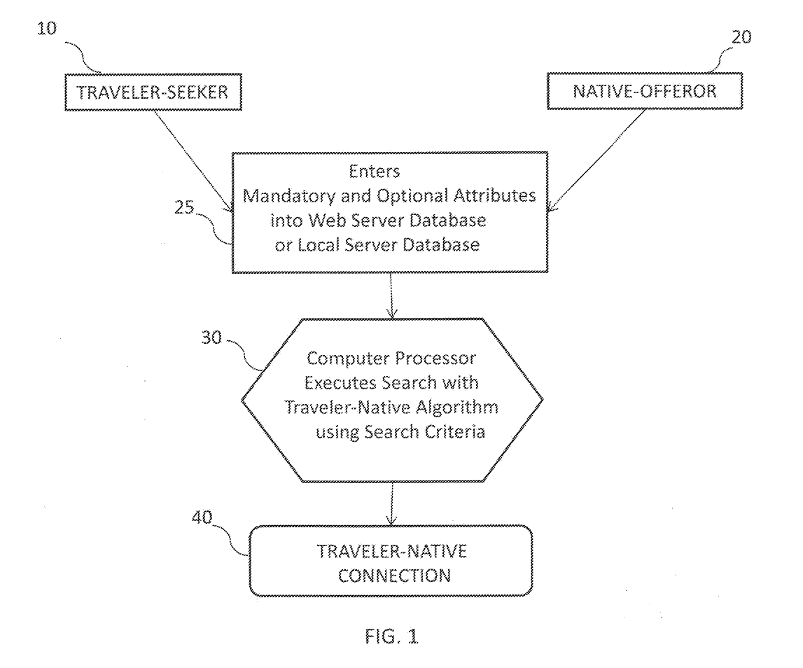

Specifically, referring now to FIG. 1, the at-home culinary experience provided by the online matching service according to the systems and methods of the present invention includes a traveler-seeker 10 and native-offerors entering mandatory and any optional attributes into a web server database or a local server database. The web server processor or local server processor executes a database search based on search criteria 25, described in more detail below, using a traveler-native matching algorithm 30 which identifies any matches, referred to as a “traveler-native connection” 40.

The web server database and/or the local server database contain registants' attributes which are located based on search criteria, which includes all of the mandatory attributes and any optional attributes entered by the registrants. The actual database is organized based on the underlying database query program and the hardware and software running on the system.

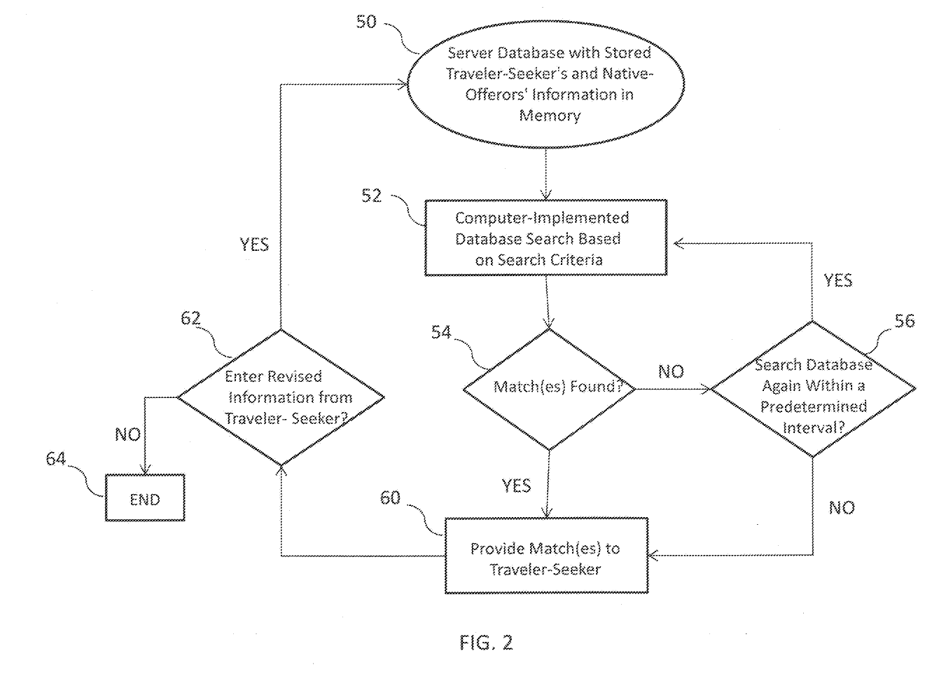

Referring now to FIG. 2, an example of a database search is provided. Information from a traveler-seeker and native-offerors are obtained and entered into the web server database or the local server database and stored in memory 50. The web server processor or local server processor (i.e., any suitable computer having a processor and memory combined with the processor commonly employed by those skilled in the art) executes a database search based on the search criteria 52 to identify any matches 54 between the traveler-seeker and the native-offerors. If one or more matches are found, the one or more matches are provided to the traveler-seeker 60 via computer, smartphone, tablet, or any other preferred means of communication, as indicated in the traveler-seeker's questionnaire. When no matches are found, one or more database searches may be performed at a frequency of predetermined intervals 56 when one or more further iterations have been requested by the traveler-seeker, as indicated in the traveler-seeker questionnaire, until a match is found or until the number of requested iterations has been completed. The invention contemplates that with native-offerors accessing the online matching service on a regular basis, further searches may eventually yield one or more matches. Alternatively, the traveler-seeker may choose to revise certain attributes 62 (such as questions 9, 10, 11, 13 and 16 listed in Table 1, above), and the database search is rerun with the revised information. If the traveler-seeker does not wish to revise the information 62, the database search ends 64.

The systems and methods of the online matching service of the invention may be implemented as computer software in the form of computer readable program code run on a general purpose computer, i.e., processor, and using a communication network. In an embodiment, the systems and methods of the invention include a computer-implemented system comprised of a web server coupled to a computer network such as the internet, or one or more local servers connected to a proprietary network such as is operated by AT&T or MCI, which connects to the web server, and access to the web server or one or more local servers by users of the online matching service.

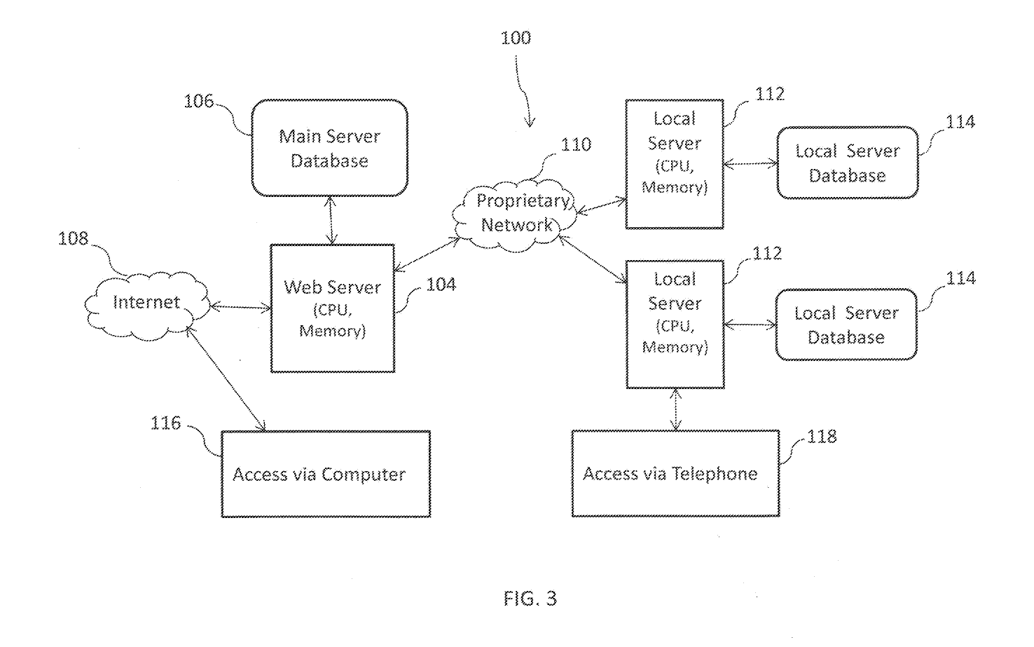

The systems and methods of the invention are more specifically described and illustrated in FIG. 3. A web server 104 is connected to a network such as the internet 108. Remotely located from the web server 104 are a number of typical local servers 112 which connect to the web server 104 via a proprietary network 110. Each local server 112 contains a local server database 114. A traveler-seeker or native-offeror accesses the system 100 via the internet 108 using a computer, smartphone, tablet (or any other form of access to the internet) 116, which accesses the web server 104, or via a land-line or mobile telephone (or any other type of telephone) 118, which accesses one of the local servers 112. The web server 104 maintains a main server database 106 which contains all of the local server databases 114 from all of the local servers 112.

In an embodiment, the web server runs a Windows operating system on a Pentium-based computer with an eight gigabyte hard disk and one hundred megabytes of random access memory (RAM).

The web server 104 and the local servers 112 are computers which include a central processing unit (CPU), memory and storage capacity (not shown). The web server 104, if accessed by the internet 108, or the local server 112, if accessed by a proprietary network 110, performs the database search using the traveler-native match algorithm shown in FIG. 1, using the information inputted by the traveler-seeker and the one or more native-offerors, and reports any matches to the traveler-seeker. The web server 104 or local server 112 may repeat the database search when no matches are found after a predetermined interval if requested by the traveler-seeker. Alternatively, the traveler-seeker may input revised attributes and have another database search performed by the web server 104 or local server 112.

Upon successful identification of one or more matches, the one or more native-offerors are contacted via their preferred means of communication (as indicated in their respective questionnaires) and provided with information regarding the traveler-seeker to whom they have been matched. The one or more native-offerors then either consents or declines to host the traveler-seeker in their home. If the one or more native-offerors consents to host the traveler-seeker, the traveler-seeker is contacted by the online matching service, remits the second payment to the online matching service, and receives the one or more native-offerors' contact information. After the one or more native-offerors successfully completes the at-home culinary experience with the traveler-seeker, proof of which is submitted by both the traveler-seeker and the one or more native-offerors to the online matching service, the one or more native-offerors receives monetary compensation from the online matching service.

It is contemplated that the systems and methods of the present invention for providing an at-home culinary experience to the traveler and the native may provide enhanced insights and understanding by the traveler and the native regarding their respective traditions, beliefs and aspirations, as well as their trials and tribulations. It also is contemplated that the systems and methods of the present invention may lead to improved local economies.

The present invention envisions that the dialogues engaged in between a traveler and a native while sharing and eating a home-cooked meal prepared, served and hosted by the native in the native's residence will foster improved bilateral relations between individuals residing in two separate geographic regions and coming from substantially dissimilar backgrounds.

It further is envisioned that the interaction between travelers and natives in such a personalized setting provided in accordance with the present invention will result in life-long connections and friendships. Hence, it is envisioned that the systems and methods for connecting travelers to natives by having them participate in an at-home culinary experience in the residence of the native will result in CHANGING THE WORLD . . . ONE MEAL AT A TIME™.

The invention, therefore, provides a unique, safe and comfortable way for people of the world to meet, communicate and enjoy a home-cooked meal in the home of a native of a geographic region traveled to by a traveler, which meeting hopefully will narrow the gap oftentimes felt between disparate people of the world, and hopefully will enlighten people from different parts of the world of our shared common humanity.

It will be appreciated by those skilled in the art that changes could be made to the embodiments described above without departing from the broad inventive concept thereof. It is understood, therefore, that this invention is not limited to the particular embodiments disclosed, but it is intended to cover modifications that are within the spirit and scope of the invention, as defined by the appended claims.

What is claimed is:

1. A computer-implemented system provided by an online matching service for matching a person traveling to a region and wishing to experience an at-home culinary experience in the home of a native of the region, comprising a web server processor or a local server processor, a web server database or a local server database, and a matching algorithm, referred to as a traveler-native match algorithm, said web server processor or said local server processor executing the traveler-native match algorithm using information stored in memory in the web server database or the local server database in order to identify matches between a person traveling to a geographic region, referred to as a traveler-seeker, said traveler-seeker wishing to experience a home-cooked meal in a residence of one or more natives of the geographic region, and one or more natives residing in the geographic region, referred to as native-offerors, said native-offerors wishing to offer a home-cooked meal and to eat the home-cooked meal in their home with the traveler-seeker, said information provided by the traveler-seeker and the one or more native-offerors, wherein the online matching service includes a registration process, an acceptance process, and a matching process.

2. The computer-implemented system of claim 1, wherein the traveler-seeker and the one or more native-offerors access the online matching service via the internet using a computer, smartphone, tablet or any other form of access to the internet which accesses a web server, or via a land-line telephone, mobile telephone or any other type of telephone which accesses a local server connected to the web server via a proprietary network.

3. The computer-implemented system of claim 2, wherein the registration process by the online matching service is comprised of the traveler-seeker and the one or more native-offerors filling out a questionnaire by providing information referred to as attributes, said attributes entered into the web server database or the local server database; wherein the acceptance process by the online matching service is comprised of verifying the truthfulness of the information provided by the traveler-seeker and the one or more native-offerors in their respective questionnaires, and conducting a background investigation of the traveler-seeker and the one or more of native-offerors to determine if the traveler-seeker and/or the one or more native-offerors have a criminal history; and wherein the matching process is executed by the web server processor or the local server processor using the traveler-native match algorithm and the information stored in memory in the web server database or the local server database.

4. The computer-implemented system of claim 3, wherein after the traveler-native matching algorithm is completed, results of the search are reported to the traveler-seeker and, when no matches are found (1) the search ends; (2) the traveler-seeker revises certain attributes in the questionnaire, the server repeats the search using the revised information, and results of the search are reported to the traveler-seeker, or (3) the server repeats the search a set number of times at a predetermined interval, and results of the search are reported to the traveler-seeker after one or more matches is identified or when no match is identified, wherein the traveler-seeker determines which of (1) or (3) occurs as provided in their traveler-seeker questionnaire.

5. The computer-implemented system of claim 3, wherein the attributes entered into the web server database or the local server database are mandatory attributes and optional attributes.

6. The computer-implemented system of claim 5, wherein the mandatory attributes of the traveler-seeker comprise their name, address, contact information, date of birth, gender, language(s) spoken, marital status, current occupation, geographic location(s) to which they will be traveling, dates and times available to attend one or more at-home culinary experiences, desired meal format(s), any dietary and/or alcohol restrictions, the names, ages and relationship of any other persons that will be accompanying the traveler-seeker to the one or more at-home culinary experiences, any criminal history, and server database search number of iterations and frequency of iterations when an initial server database search yields no matches; and the mandatory attributes of the plurality of native-offerors comprise their name, address, contact information, date of birth, gender, language(s) spoken, marital status, current occupation, number of people living in residence and number of children, date(s) and time(s) they are available to host one or more at-home culinary experiences, types of meal formats they can provide, food items they can offer, any dietary and/or alcohol restrictions, maximum number of people they are able to accommodate for an at-home culinary experience, and any criminal history.

7. The computer-implemented system of claim 5, wherein the optional attributes of the traveler-seeker comprise hobbies and personal interests, religious affiliation and/or spiritual beliefs, and any other information they believe important regarding their preferences and/or restrictions; and the optional attributes of the plurality of native-offerors comprise whether they own or rent their residence, hobbies and personal interests, religious affiliation and/or spiritual beliefs, and any other information they believe important regarding their preferences and/or restrictions.

8. The computer-implemented system of claim 6, wherein the meal format comprises a sit-down or a buffet breakfast, brunch, lunch, dinner or picnic.

9. The computer-implemented system of claim 1, wherein the online matching service charges a first fee to the traveler-seeker for searching the server database one or more times, and a second fee after the traveler-seeker chooses to partake in the at-home culinary experience with one or more matched native-offerors identified by the traveler-native match algorithm, or when the traveler-seeker revises certain attributes so that an additional search is executed by the web server or the local server.

10. The computer-implemented system of claim 1, wherein the one or more native-offerors receives monetary compensation from the online matching service after successful completion of the at-home culinary experience with the traveler-seeker, which successful completion is reported to the online matching service by both the traveler-seeker and the one or more native offerors.

11. A computer-implemented method for providing a person traveling to a geographic region an at-home culinary experience in the home of a native of the geographic region, said method provided by an online matching service and comprising:
accessing a computer-implemented system by a person traveling to a geographic region, referred to as a traveler-seeker, said traveler-seeker wishing to experience a home-cooked meal in a residence of one or more natives of the geographic region; and by one or more natives residing in the geographic region, referred to as native-offerors, said native-offerors wishing to offer a home-cooked meal and eating the home-cooked meal in their home with the traveler-seeker, said accessing accomplished via the internet or via a telephone;
registering for the online matching service by the traveler-seeker and the one or more native-offerors, said registration comprised of the traveler-seeker and the one or more native-offerors filling out a questionnaire by providing information referred to as attributes, said attributes entered into a web server database or a local server database;
accepting the traveler-seeker and the one or more native-offerors by the online match service, said acceptance comprised of the online matching service verifying the truthfulness of the information provided by the traveler-seeker and the one or more native-offerors in their respective questionnaires, and conducting a background investigation of the traveler-seeker and the one or more of native-offerors to confirm that the traveler-seeker and/or the one or more native-offerors have no criminal history;
matching the traveler-seeker with one or more native-offerors, said matching performed by a web server processor or a local server processor which executes a matching algorithm, referred to as a traveler-native match algorithm, using information stored in memory in the web server database or local server database, in order to identify any matches between the traveler-seeker and the one or more native-offerors; and
reporting the results of the database search by the web server processor or the local server processor to the traveler-seeker and to any matched native-offerors.

12. The computer-implemented method of claim 11, wherein the traveler-seeker and the one or more native-offerors access the online matching service via the internet using a computer, smartphone, tablet or any other form of access to the internet which accesses a web server, or via a land-line telephone, mobile telephone or any other type of telephone which accesses a local server connected to the web server via a proprietary network.

13. The computer-implemented method of claim 12, wherein when no matches are found (1) the search ends; (2) the traveler-seeker revises certain attributes in the questionnaire, the server repeats the search using the revised information, and results of the search are reported to the traveler-seeker, or (3) the server repeats the search a set number of times at a predetermined interval, and results of the search are reported to the traveler-seeker after identification of a match or when no match is identified, wherein the traveler-seeker determines which of (1) or (3) occurs as provided in the traveler-seeker questionnaire.

14. The computer-implemented method of claim 11, wherein when one or more native-offerors are identified and reported to the traveler-seeker, the traveler-seeker is given the information provided by the one or more native-offerors in their questionnaire so that the traveler-seeker can decide whether to contact the one or more native-offerors in order to arrange the at-home culinary experience in the residence of the one or more native-offerors when the traveler-seeker travels to their geographic region.

15. The computer-implemented method of claim 11, wherein the attributes entered into the web server database or the local server database are mandatory attributes and optional attributes.

16. The computer-implemented method of claim 15, wherein the mandatory attributes of the traveler-seeker comprise their name, address, contact information, date of birth, gender, language(s) spoken, marital status, current occupation, geographic location(s) to which they will be traveling, dates and times available to attend one or more at-home culinary experiences, desired meal format(s), any dietary and/or alcohol restrictions, the names, ages and relationship of any other persons that will be accompanying the traveler-seeker to the one or more at-home culinary experiences, any criminal history, and server database search number of iterations and frequency of iterations when an initial server database search yields no matches; and the mandatory attributes of the plurality of native-offerors comprise their name, address, contact information, date of birth, gender, language(s) spoken, marital status, current occupation, number of people living in residence and number of children, date(s) and time(s) they are available to host one or more at-home culinary experiences, types of meal formats they can provide, food items they can offer, any dietary and/or alcohol restrictions, maximum number of people they are able to accommodate for an at-home culinary experience, and any criminal history.

17. The computer-implemented method of claim 15, wherein the optional attributes of the traveler-seeker comprise hobbies and personal interests, religious affiliation and/or spiritual beliefs, and any other information they believe important regarding their preferences and/or restrictions; and the optional attributes of the plurality of native-offerors comprise whether they own or rent their residence, hobbies and personal interests, religious affiliation and/or spiritual beliefs, and any other information they believe important regarding their preferences and/or restrictions.

18. The computer-implemented method of claim 16, wherein the meal format comprises a sit-down or a buffet breakfast, brunch, lunch, dinner or picnic.

19. The computer-implemented method of claim 11, wherein the online matching service charges a first fee to the traveler-seeker for searching the server database one or more times, and a second fee after the traveler-seeker chooses to partake in the at-home culinary experience with one or more matched native-offerors identified by the traveler-native match algorithm, or when the traveler-seeker revises certain attributes so that an additional search is executed by the web server or the local server.

20. The computer-implemented method of claim 11, wherein the one or more native-offerors receives monetary compensation from the online matching service after successful completion of the at-home culinary experience with the traveler-seeker, which successful completion is reported to the online matching service by both the traveler-seeker and the one or more native-offerors.
